(19) United States
(12) Patent Application Publication
(10) Pub. No.: US 2020/0047213 A1
(43) Pub. Date: Feb. 13, 2020

(54) DEVICE COMPRISING AN AXIAL PISTON PUMP FOR APPLYING A FLUID PRODUCT TO A SUBSTRATE

(71) Applicant: EXEL INDUSTRIES, Épernay (FR)

(72) Inventors: Romain GAILLET, Saint-Lô (FR); Philippe DE TALHOUET, Paris (FR)

(21) Appl. No.: 16/606,176

(22) PCT Filed: Apr. 17, 2018
(86) PCT No.: PCT/EP2018/059792

§ 371 Date: Oct. 17, 2019

(30) Foreign Application Priority Data
Apr. 19, 2017 (FR) 1753384

(51) Int. Cl. B05C 11/10; F04B 5/02; B05B 13/04

(52) U.S. Cl. CPC B05C 11/1002; B05B 13/0431; F04B 5/02

(57) ABSTRACT

An application device, intended for applying at least one fluid product to a substrate, including an application member for formatting the or each fluid product so that it can be applied to the substrate, the application member having an outlet orifice via which the fluid product(s) exits (exit) the application device. The application device also includes, for at least one fluid product, a metering pump for supplying the application member with the said fluid product and a device for supplying the fluid product to the metering pump. This metering pump consists in an axial piston pump.

### CROSS-REFERENCE TO RELATED APPLICATIONS

This application claims benefit under 35 USC § 371 of PCT Application No. PCT/EP2018/059792 entitled DEVICE COMPRISING AN AXIAL PISTON PUMP FOR APPLYING A FLUID PRODUCT TO A SUBSTRATE, filed on Apr. 17, 2018 by inventors Romain Gaillet and Philippe de Talhouette. PCT Application No. PCT/EP2018/059792 claims priority of French Patent Application No. 17 53384, filed on Apr. 19, 2017.

### FIELD OF THE INVENTION

The present invention relates to a device for applying a fluid product on a substrate, the application device being of the type comprising an application member, for shaping the or each fluid product for its application on the substrate, the application member having an outlet orifice for the fluid product(s) outside the application device, the application device also comprising, for at least one fluid product, a metering pump for the supply of the application member with said fluid product and a device for supplying the fluid product to the metering pump.

“Fluid product” here and hereinafter refers to a product having a viscosity of between 1 centipoise (CPs) and 2 million centipoises, this viscosity for example being measured using a Brookfield Plan Cone viscosimeter under normal temperature and pressure conditions. This expression thus encompasses products in liquid state, perfectly deformable and with a low viscosity, as well as products generally described as “pasty”, more viscous than liquids and having a state midway between the liquid state and the solid state.

The invention also relates to an applicator robot comprising such an application device, and a method for applying a fluid product on a substrate using such an application device.

### BACKGROUND OF THE INVENTION

In the context of the application of fluid products on surfaces, for example in order to deposit lines of glue on said surfaces or to coat said surfaces using paint, it is sometimes necessary to have precise control of the flow rate of the fluid product leaving the application device; in this case, reference is made to “metering”. To that end, most often, single-acting supply pumps are used as pumps, called “shot meters”. These pumps comprise a chamber, a piston movable inside the chamber, a suction valve and a discharge valve. When the piston moves in a first direction inside the chamber, it causes a vacuum that opens the suction valve and the filling of the chamber with the fluid product. When the piston moves in the opposite direction, it causes an overpressure that opens the discharge valve and causes the expulsion of the fluid product outside the chamber, the fluid product thus expelled feeding the application member. The precise calibration makes it possible to control the volume of fluid product dispensed upon each round trip of the piston inside the chamber.

The advantage of these metering units lies in their simplicity and the control of the dispensed volume. A problem arises, however, when one wishes to apply a greater volume of product to the volume of the chamber: in this case, the metering unit must fill its chamber during the application; yet, during this transitional phase, the metering unit is no longer supplied, which causes an interruption to the application of the fluid product and a significant disruption of the output flow rate.

To overcome this problem, it has been proposed to install two metering unit in parallel, the control law of these metering units being suitable so that, when a first of the metering units is in the filling phase, the second metering unit offsets the flow rate related to the interruption of the supply by the first metering unit; thus, the application member sees a constant supply flow rate. However, the installation of a second metering unit involves a substantial additional cost, metering units indeed being very expensive systems. Furthermore, it is very complicated to establish a suitable command law for the supply flow rate of the application member to be constant.

Another known solution consists of using, as supply pump, a double-acting pump, that is to say, a pump that, at the same time that it expels the fluid product contained in a first half of the chamber, suctions fluid product into the second half the chamber, and vice versa. Such a pump in fact allows a quasi-continuous supply such that, by controlling the rising and falling piston flow rates, one manages to have a practically constant supply flow rate of the application member.

A problem arises, however, during the inversion of the movement of the piston. Indeed, in this step, the speed of the piston is canceled out, which causes an interruption, albeit brief, but nevertheless present, of the output flow rate.

### SUMMARY OF THE DESCRIPTION

The invention thus aims to propose a cost-effective solution to the problem of maintaining a constant application flow rate of a product on a substrate. Other aims of the invention consist of proposing a compact and suitable solution for fluid products with a high viscosity.

To that end, the invention relates to an application device of the aforementioned type, wherein the metering pump consists of an axial piston pump.

According to specific embodiments of the invention, the application device also has one or more of the following features, considered alone or according to any technically possible combination(s):
the supply device is suitable for supplying the fluid product to the metering pump at a pressure greater than the pressure of the fluid product leaving the metering pump;
the supply device comprises a booster pump and a booster pipe fluidly connecting an outlet of the booster pump to an inlet of the metering pump;
the booster pump consists of a double-acting pump;
the supply device comprises a vessel containing the fluid product, an inlet of the booster pump being fluidly connected to said vessel;
the supply device is suitable for supplying the fluid product to the metering pump at a pressure below the pressure of the fluid product leaving the metering pump;
the fluid product has a viscosity of between 1 centipoise and 2 million centipoises, advantageously between 15 and 250 centipoises or between 3000 and 300,000 centipoises;
the application device comprises a valve fluidly inserted between the metering pump and the application member;
the application device comprises an electric motor for rotating the axial piston pump;
the metering pump and the application member together form a monobloc assembly.

The invention also relates to an installation for the application of a fluid product on a substrate, the installation comprising an articulated arm formed by a plurality of segments articulated to one another, a wrist mounted at one end of the articulated arm, and an application device as defined above, the application member of which is attached on the wrist.

According to specific embodiments of the invention, the facility also has one or more of the following features, considered alone or according to any technically possible combination(s):
the metering pump is attached to one of the segments of the articulated arm and preferably to the segment closest to the wrist;
the metering pump is arranged at the wrist;
the metering pump is arranged at a distance from the application member of less than 1 m and preferably less than 50 cm.

The invention also relates to a method for applying a product on a substrate, comprising the following steps:
providing an application device as defined above, and
supplying the metering pump with fluid product.

### BRIEF DESCRIPTION OF THE DRAWINGS

Other features and advantages of the invention will appear upon reading the following description, provided solely as an example and done in reference to the appended drawings, in which:

FIG. 1 is a perspective view of an installation according to the invention, and

FIG. 2 is a block diagram of an application device of the installation according to FIG. 1.

### DETAILED DESCRIPTION

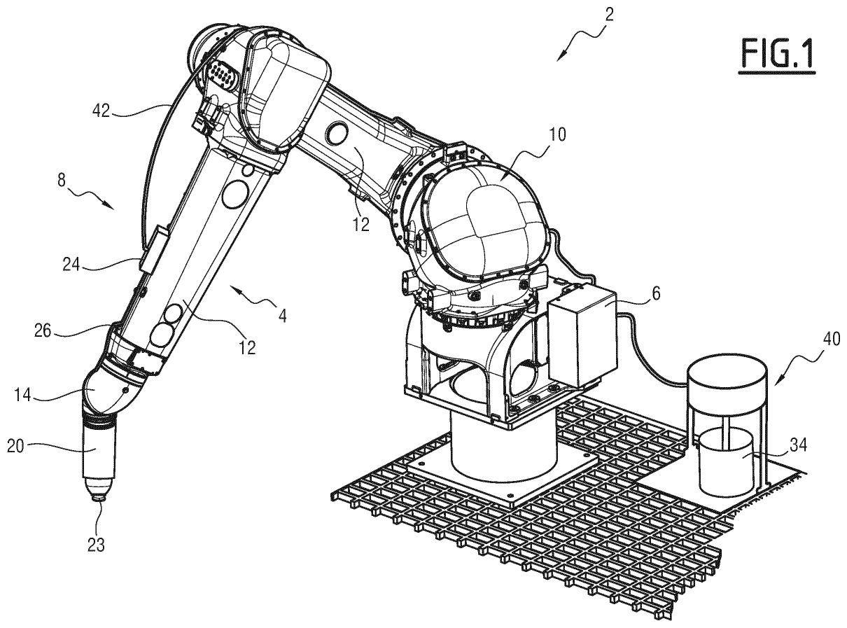

The installation 2 shown in FIG. 1 is intended for the application of a fluid product on a substrate. In a known manner, it comprises a multiaxial robot 4, a control cabinet 6 to control the robot 4, and an application device 8 for the application of the fluid product on the substrate.

The multiaxial robot 4 comprises, in a known manner, an articulated arm 10 made up of a plurality of segments 12 articulated relative to one another, and a wrist 14 mounted at one end of the articulated arm 10.

The application device 8 in turn comprises an application member 20, and a system 22 for supplying the application member 20 with fluid product.

The application device 20 is suitable for shaping the fluid product for its application on the substrate. To that end, the application member 20 comprises an outlet orifice 23 for the exit of the fluid product outside the application device 8, this outlet orifice 23 typically being made up of a nozzle.

According to the considered application, the application member 20 can assume different forms. Thus, in the illustrated example, the application member 20 is made up of an automatic gun; the shape of the outlet orifice 23 then determines the deposition mode of the fluid product on the substrate, which can be deposited: in spiral form, in the form of a wide strip, in line form, or in sprayed form. In a variant, the application member is formed by a manual gun, or by a rotary bowl sprayer.

The application member 20 is attached on the handle 14 of the robot 4.

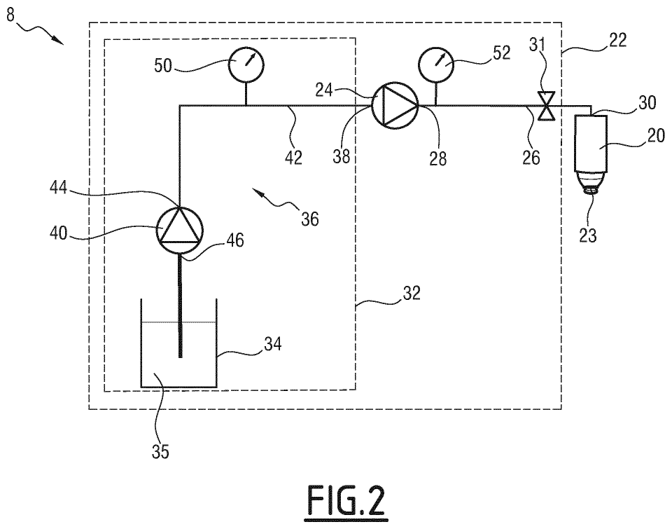

In reference to FIG. 2, the supply system 22 in turn comprises a metering pump 24 for supplying the application device 20 with fluid product having a predetermined flow rate, a supply pipe 26 fluidly connecting an outlet 28 of the metering pump 24 to an inlet 30 of the application member 20, a valve 31, and a device 32 for supplying fluid product to the metering pump 24.

According to the invention, the metering pump 24 is made up of an axial piston pump. Such axial piston pumps are commonly commercially available and are particularly compact and cost-effective. As a result, the use of such an axial piston pump for the metering pump 24 does not present a substantial excess cost.

For example, the axial piston pump is made up of 5 chambers (not shown) each having an individual volume substantially equal to 1 cm³, for a total volume of the pump substantially equal to 5 cm³; such a pump is well suited to the metering of products with low flow rates. In a variant, for the metering of products with higher flow rates, the volume of the axial piston pump is greater than 5 cm³, in particular greater than 10 cm³, and is for example substantially equal to 20 cm³. This increase in the total volume is done by increasing the individual volume of each chamber and/or increasing the number of chambers.

Advantageously, the application device 8 comprises an electric motor (not shown) for rotating the axial piston pump, which makes it possible to have a more compact pump 24 plus motor assembly with a better efficiency than if the pump 24 had used pneumatic driving. Furthermore, the electric motor allows effective control of the driving of the axial piston pump and therefore better control of the output flow rate of the pump 24.

As shown in FIG. 1, the metering pump 24 is arranged as close as possible to the application member 20, that is to say at a distance from the application member 20 of less than 1 m and preferably less than 50 cm. To that end, the metering pump 24 is attached to one of the segments 12 of the articulated arm 10, in particular to the last segment 12 before the wrist 14, as shown in FIG. 1, or directly to the wrist 14. Such a position of the metering pump 24 is partially made possible by its compactness. This position allows excellent reactivity during beginning and end of application and/or change of setpoint phases.

The valve 31 is intended to selectively close and open the supply of the outlet orifice 23 with fluid product.

To that end, the valve 31 is placed on the supply pipe 26, or integrated directly into the application member 20, so as to be inserted between the metering pump 24 and the outlet orifice 23. This valve 31 is also movable between a closed position, in which it closes off the supply pipe 26, thus preventing the supply of the application member 20 with fluid product, and an open position, in which the valve 31 frees the supply pipe 26, thus making it possible to supply the application member 20 with fluid product.

The valve 31 is typically made up of a sliding gate, a needle, or a distributor.

The supply device 32 comprises a vessel 34 containing the fluid product, referenced 35 in FIG. 2, and a fluid transfer system 36 for transferring the fluid product 35 contained in the vessel 34 to an inlet 38 of the metering pump 24.

The fluid product 35 is typically made up of a product with a high viscosity, i.e., the viscosity of which is greater than 3000 centipoises. Examples of such high-viscosity products are typically putties or elastomer or epoxy glues. Advantageously, the fluid product 35 has a viscosity of between 3000 and 300,000 centipoises.

The fluid transfer system 36 is then suitable for supplying the fluid product to the metering pump 24 at a pressure higher than a level value of between 1.1 times and 100 times the pressure of the fluid product at the output of the metering pump 24 and in particular substantially equal to 1.6 times the pressure of the fluid product at the output of the metering pump 24. Such a pressure value was in fact discovered to be necessary in order to obtain a constant output flow rate when the fluid product 35 is a high-viscosity product.

To that end, the fluid transfer system 36 comprises a booster pump 40 for pumping the fluid product 35 into the vessel 34, and a booster pipe 42 fluidly connecting an outlet 44 of the booster pump 40 to the inlet 38 of the metering pump 24.

The booster pump 40 comprises an inlet 46 fluidly connected to the vessel 34.

The booster pump 40 is suitable for maintaining a pressure of fluid product in the booster pipe 42 above the level value more than 90% of the time during the application of the fluid product. This proportion is calculated as being the ratio of the time during which the pressure of fluid product in the booster pipe 42 is kept above the level value while the coating product is applied using the application device 8 over the entire duration during which the coating product is applied using the application device 8.

To that end, the booster pump 40 is typically made up of a double-acting pump designed to discharge the fluid product 35 at a pressure at least equal to the level value. Thus, when fluid product is applied using the application device 8, the only periods during which the pressure of the fluid product 35 at the inlet of the metering pump 24 is likely to drop below the level value are the inversion phases of the movement direction of the piston of the pump, these inversion phases representing less than 10% of the operating duration of the double-acting pump.

The booster pipe 42 is suitable for withstanding an internal pressure of 500 bars. It typically comprises an upstream segment (not shown), connected to the outlet 44 of the booster pump 40, formed by a pipe with a diameter substantially equal to 1.90 cm and a length of 1.5 m, a downstream segment (not shown), connected to the inlet 38 of the metering pump 24, formed by a pipe with a diameter substantially equal to 0.95 cm and a length of 1.5 m, and an intermediate segment (not shown), fluidly inserted between the upstream and downstream segments and formed by a pipe with a diameter substantially equal to 1.27 cm and a length of 10 m.

The application device 8 also comprises a system for controlling the operation of said application device 8. This control system comprises a first pressure sensor 50 for measuring the pressure in the booster pipe 42 and a second pressure sensor 52 for measuring the pressure in the supply pipe 26. The second pressure sensor 52 is in particular arranged upstream from the valve 31.

An application method of the fluid product 35 using the installation 2 will now be described.

First of all, during a first step, the installation 2 is provided.

The booster pump 40 is next activated. The latter then begins to pump the product 35 into the vessel 34 and to discharge it into the booster pipe 42.

The pressure at the inlet of the metering pump 24 is monitored using the first pressure sensor 50. Once a target pressure is reached that is higher than the first level value, for example equal to 25 bars, the metering pump 24 is started, and the valve 31 is opened. The application of the fluid product 35 on a substrate can then begin.

Throughout the entire application duration of the fluid product 35, the flow rate of the fluid product 35 at the outlet orifice 23 remains substantially constant. This makes it possible, in the case where the fluid product is deposited in line form, to obtain a line with a regular appearance. In particular, the inversion phases of the double-acting pump 40 are not visible on the obtained line.

Optionally, it is possible to modify the flow rate at the outlet orifice 23, during application, by modifying the rotation speed of the axial piston pump 24.

When one wishes to change the substrate on which the product 35 is applied, the valve 31 is closed. Thus, the supply of the application member 20 is interrupted, which makes it possible to remove the substrate on which the product 35 has already been applied and to place a new, blank one without wasting fluid product. The valve 31 is next reopened, so as to allow the application of the fluid product on the new substrate.

When the vessel 34 is empty, it is replaced with a new, full vessel 34.

The method has thus been implemented for different booster pressures and different rotation speeds of the axial piston pump 24. The results are given below:

| | Test 1 | Test 2 | Test 3 | Test 4 | Test 5 | Test 6 | Test 7 | Test 8 | Test 9 |
|---|---|---|---|---|---|---|---|---|---|
| Pᵢₙₗₑₜ (b) | 25.00 | 25.00 | 25.00 | 25.00 | 50.00 | 50.00 | 50.00 | 50.00 | 70.00 |
| Vₚᵤₘₚ (tr/s) | 0.21 | 0.42 | 0.83 | 1.67 | 0.21 | 0.42 | 0.83 | 1.67 | 4.16 |
| Pₒᵤₜₗₑₜ (b) | 6.25 | 7.75 | 10.50 | 15.75 | 7.75 | 8.50 | 11.25 | 16.25 | 25.00 |
| Flow rate | 1.02 | 2.04 | 4.08 | 8.16 | 1.02 | 2.04 | 4.08 | 8.16 | 20.5 |
| (cc/s) | | | | | | | | | |

Pᵢₙₗₑₜ designates the pressure at the inlet of the metering pump 24 measured by the first pressure sensor 50, Vₚᵤₘₚ designates the rotation speed of the metering pump 24, Pₒᵤₜₗₑₜ designates the pressure in the supply pipe 26, measured by the second pressure sensor 52, and Flow rate designates the fluid product flow rate at the outlet orifice 23.

As one can see, the outlet flow rate is an affine function of the rotation speed of the metering pump 24 and is independent of the pressure upstream from the metering pump 24, which makes the adjustment of this outlet flow rate particularly easy.

Furthermore, the adjustment of the booster pressure makes it possible, at a constant outlet flow rate, to modify the pressure in the supply pipe 26. It is thus possible to adapt the supply pressure of the application member 20 as a function of the desired use, which is particularly interesting when the fluid product is applied in sprayed form.

Owing to the invention, it is thus possible, for a low cost, to apply a fluid product on a substrate while controlling the application flow rate uninterrupted over long periods, and with minimal pressure variations.

Furthermore, the application flow rate can be adjusted easily, and the supply pressure of the application member can, at a constant flow rate, be modified easily.

In the example described above, the application device 8 is suitable for the application of a single fluid product at a time. In a variant (not shown), the application device 8 is suitable for the application of several fluid products at once. In this case, the application device 8 comprises, aside from the supply system 22, at least one other supply system, one per fluid product other than the fluid product 35, to supply the application member 20 with each of these fluid products. Advantageously, at least one of these other supply systems then comprises a metering pump such as the metering pump 24 described above.

Furthermore, in the example described above, the fluid product 35 used is a high-viscosity product. In a variant (not shown), the fluid product 35 is made up of a product with a low viscosity, typically a paint with a viscosity typically of between 15 and 250 centipoises. The fluid transfer system 36 is then suitable for supplying the fluid product to the metering pump 24 at a pressure of between one tenth and nine tenths of the pressure of the fluid product 35 at the outlet of the metering pump 24.

Still in the example described above, the metering pump 24 and the supply member 20 are described as forming mutually independent elements that are connected to one another by the supply pipe 26. In a variant (not shown), the metering pump 24 and the application member 20 together form a monobloc assembly within which the metering pump 24 and the application member 20 are secured to one another, with no supply pipe inserted between the metering pump 24 and the application member 20.

1. An application device for applying at least one fluid product on a substrate, comprising:
an application member adapted for shaping the or each fluid product for its application on the substrate, the application member comprising an outlet orifice for the fluid product(s) outside the application device; and
for at least one fluid product:
a metering pump for the supply of said application member with the fluid product product, the metering pump comprising an axial piston pump; and
a supply device for supplying the fluid product to said metering pump.

2. The application device according to claim 1, wherein said supply device is suitable for supplying the fluid product to said metering pump at a pressure greater than the pressure of the fluid product leaving said metering pump.

3. The application device according to claim 2, wherein said supply device comprises:
a booster pump; and
a booster pipe fluidly connecting an outlet of said booster pump to an inlet of said metering pump.

4. The application device according to claim 3, wherein said booster pump comprises a double-acting pump.

5. The application device according to claim 3, wherein said supply device comprises a vessel containing the fluid product, an inlet of said booster pump being fluidly connected to said vessel.

6. The application device according to claim 1, wherein said supply device is suitable for supplying the fluid product to said metering pump at a pressure below the pressure of the fluid product leaving said metering pump.

7. The application device according to claim 1, wherein the fluid product has a viscosity of between 1 centipoise and 2 million centipoises.

8. The application device according to claim 1, further comprising a valve fluidly inserted between said metering pump and said application member.

9. The application device according to claim 1, comprising an electric motor for rotating said axial piston pump.

10. The application device according to claim 1, wherein said metering pump and said application member together form a monobloc assembly.

11. An installation for the application of a fluid product on a substrate, the installation comprising:
an articulated arm formed by a plurality of segments articulated to one another;
a wrist mounted at one end of said articulated arm; and
an application device according to claim 1, the application member of which is attached on said wrist.

12. The installation according to claim 11, wherein said metering pump is attached to one of the segments of said articulated arm.

13. The installation according to claim 12, wherein said metering pump is arranged at said wrist.

14. The installation according to claim 12, wherein said metering pump is arranged at a distance from said application member less than 1 m.

15. A method for applying a fluid product (35) on a substrate, comprising:
providing an application device according to claim 1; and
supplying said metering pump with fluid product.

16. The application device according to claim 7, wherein the fluid product has a viscosity of between 15 and 250 centipoises or between 3000 and 300000 centipoises.

17. The installation according to claim 12, wherein said metering pump is attached to the segment closest to said wrist.

18. The installation according to claim 12, wherein said metering pump is arranged at a distance from said application member of less than 50 cm.
